(19) United States
(12) Patent Application Publication
(10) Pub. No.: US 2024/0349365 A1
(43) Pub. Date: Oct. 17, 2024

(54) NETWORK FUNCTION CREATION METHOD AND COMMUNICATION APPARATUS

(71) Applicant: HUAWEI TECHNOLOGIES CO., LTD., Shenzhen (CN)

(72) Inventors: Weijun XING, Shanghai (CN); Shaoyun WU, Shanghai (CN); Yang WANG, Shenzhen (CN); Xueqiang YAN, Shanghai (CN); Mingyu ZHAO, Shanghai (CN)

(73) Assignee: HUAWEI TECHNOLOGIES CO., LTD., Shenzhen (CN)

(21) Appl. No.: 18/756,103

(22) Filed: Jun. 27, 2024

Related U.S. Application Data
(63) Continuation of application No. PCT/CN2022/141239, filed on Dec. 23, 2022.

(30) Foreign Application Priority Data
Dec. 31, 2021 (CN) 202111676507.5

(51) Int. Cl. H04W 76/10; H04W 8/20

(52) U.S. Cl. CPC H04W 76/10; H04W 8/20

(57) ABSTRACT

This application provides a network function creation method and a communication apparatus. The network function creation method includes: A first entity receives a first request message, where the first request message is used to request to create or select a user network corresponding to a terminal device, and the first request message includes a user identifier of the terminal device. The first entity creates or selects a control plane function based on the user identifier, where the control plane function is used to create or select a user plane function corresponding to the control plane function, and the user plane function is used to support a subscription service corresponding to the user identifier. According to the network function creation method, the control plane function can be created, and the user plane function meeting all session subscriptions of a user can be created by using the control plane function.

### CROSS-REFERENCE TO RELATED APPLICATIONS

This application a continuation of International Application No. PCT/CN2022/141239, filed on Dec. 23, 2022, which claims priority to Chinese Patent Application No. 202111676507.5, filed on Dec. 31, 2021. The disclosures of the aforementioned applications are hereby incorporated by reference in their entireties.

### TECHNICAL FIELD

This application relates to the field of communication technologies, and in particular, to a network function creation method and a communication apparatus.

### BACKGROUND

In a 5th generation (5G) communication system, user plane data of a terminal device is carried by a protocol data unit (PDU) session, and each PDU session corresponds to a data network name (DNN) and a slice combination. When the terminal device needs to create a PDU session based on information about a slice and information about a DNN, the terminal device needs to send a PDU session establishment request message to an access and mobility management function (AMF) network element. The AMF network element selects, based on the information about the slice, a session management function (SMF) serving the slice, and sends the PDU session establishment request message of the terminal device to the SMF network element. Further, the SMF network element obtains session subscription information of the terminal device based on the DNN and the information about the slice, and determines a user plane function (UPF) based on information such as the DNN, the information about the slice, a session and service continuity (SSC) mode (Mode), and a location of the terminal device.

A core network architecture of a 5G network is designed based on network logic. To enable the network to better serve users, in a communication system evolved after 5G, a network architecture is more expected to be centered on user requirements. If the user requirements need to be centered on, fine-grained function division needs to be performed on network element functions in a network architecture from the perspective of a user terminal while ensuring function integrity of a network structure. However, after the fine-grained division is performed on the network element functions, how to create a user plane resource (or referred to as a link) to support a user plane function is an urgent problem to be resolved.

### SUMMARY

Embodiments of this application provide a network function creation method and a communication apparatus. According to the network function creation method, a control plane function can be created, and a user plane function that supports all subscription services of a user can be created by using the control plane function.

According to a first aspect, an embodiment of this application provides a network function creation method. In the method, a first entity receives a first request message, where the first request message is used to request to create or select a user network corresponding to a terminal device, and the first request message includes a user identifier of the terminal device. The first entity creates or selects a control plane function based on the user identifier, where the control plane function is used to create or select a user plane function corresponding to the control plane function, and the user plane function is used to support a subscription service corresponding to the user identifier.

Based on the method described in the first aspect, the user plane function created by a core network by using the control plane function can meet all subscription information of a user. In comparison to a manner in which the core network obtains session subscription information from the user subscription information only after receiving a session creation requirement of the user each time, a manner of creating the user plane function can improve efficiency of providing the user with a network service, and improve system security.

In a possible implementation, the first request message further includes first information of the user network. According to the possible implementation, a specified user network may be created based on the first request message, so that the control plane function or the user plane function of the user network better meets a user requirement.

In a possible implementation, the first information of the user network includes an identifier of the user network or a type of the user network. According to the possible implementation, the user may use the identifier of the user network to explicitly indicate the user network that needs to be accessed and used. The type of the user network provides a vague network requirement, so that the user network can be created or selected for the user on a network side based on the vague network requirement.

In a possible implementation, the first entity receives a second request message from the control plane function, where the second request message is used to request to create or select the user plane function, and the second request message carries first network attribute information; the first entity creates or selects the user plane function based on the first network attribute information; and the first entity sends information about the user plane function to the control plane function. According to the possible implementation, the first entity creates or selects the user plane function based on a request of the control plane function, so that direct contact between the first entity and user information is avoided, and user data security is improved.

In a possible implementation, the first entity receives a second request message from the control plane function, where the second request message is used to request to create or select the user plane function, the second request message carries second information of the user network, and the second information of the user network includes the identifier of the user network or the type of the user network; the first entity creates or selects the user plane function based on the second information of the user network; and the first entity sends information about the user plane function to the control plane function. According to the possible implementation, the first entity creates or selects the user plane function based on a request of the control plane function, so that direct contact between the first entity and user information is avoided, and user data security is improved.

In a possible implementation, the first entity determines second network attribute information based on the second information of the user network, and the first entity creates or selects the user plane function based on the second network attribute information. In this possible implementation, the control plane function only needs to send the second information of the user network, so that the first entity can create or select the user plane function, and content of a message is simplified.

In a possible implementation, the information about the user plane function includes one or more of an identifier of the user plane function, address information of the user plane function, or a tunnel endpoint identifier corresponding to the user plane function. In the possible implementation, the control plane function may obtain the information about the user plane function, and configure a user plane communication link for the user based on the information, to provide a user data forwarding service.

In a possible implementation, the first network attribute information includes one or more of a data network name, a maximum bit rate, a session type of the user plane function, a service continuity type of the user plane function, or location information of the terminal device. In the possible implementation, the first entity may determine a specific user plane function based on the first network attribute information. For example, an external network interface that needs to be connected to the user plane function is determined based on the data network name, maximum bandwidth needed by the user plane function is quantified based on the maximum bit rate, an IP data stream or a non-IP data stream that needs to be supported by the user plane function is determined based on the session type of the user plane function, a switching function that can be supported by the user plane function is determined based on the service continuity type of the user plane function, and a user plane function that can be connected to an access network device in a current location area of the terminal based on the location of the terminal device.

In a possible implementation, the second network attribute information includes one or more of a data network name, a maximum bit rate, a session type of the user plane function, or a service continuity type of the user plane function.

In a possible implementation, the first entity receives processed user subscription information based on the user identifier, and the first entity sends the processed user subscription information to the control plane function, where the processed user subscription information is used to create or select the user plane function. According to this method, a case in which the first entity perceives the user subscription information is avoided, and security of the user subscription information is improved.

In a possible implementation, the first request message is one of a non-access stratum message, a registration request message, a service request message, a session establishment message, or a user network creation request message. In the possible implementation, the user may initiate a user network control request to the network side.

In a possible implementation, the first request message is from the terminal device or a second entity. In the possible implementation, the first entity may directly obtain the first request message from the terminal, or may obtain the first request message of the terminal from the second entity. According to the method, a plurality of implementations in which the first entity obtains the first request message are provided.

In a possible implementation, the first entity is configured to manage or operate the user network, and the second entity is configured to connect the terminal device to the user network or the core network.

According to a second aspect, an embodiment of this application provides another network function creation method. In the method, a control plane function obtains a user identifier, and the control plane function creates or selects a user plane function corresponding to the control plane function, where the user plane function is used to support a subscription service corresponding to the user identifier.

Based on the network function creation method provided in the second aspect, for beneficial effects of the second aspect, refer to the beneficial effects of the first aspect. Details are not described herein again.

In a possible implementation, the control plane function obtains user subscription information corresponding to the user identifier, and the control plane function creates or selects, based on the user subscription information, the user plane function corresponding to the control plane function.

In a possible implementation, the control plane function receives processed user subscription information corresponding to the user identifier from a first entity, and the control plane function obtains the user subscription information based on the processed user subscription information.

In a possible implementation, the control plane function determines first network attribute information based on the user subscription information, and the control plane function creates or selects, based on the first network attribute information, the user plane function corresponding to the control plane function.

In a possible implementation, the control plane function determines first network attribute information based on the user subscription information; the control plane function sends a second request message to the first entity, where the second request message is used to request to create or select the user plane function, and the second request message carries the first network attribute information; and the control plane function receives information about the user plane function from the first entity.

In a possible implementation, the control plane function determines second information of the user network, where the second information of the user network includes an identifier of the user network or a type of the user network; and the control plane function sends a second request message to a first entity, where the second request message is used to request to create or select the user plane function, and the second request message carries the second information of the user network.

In a possible implementation, the information about the user plane function includes one or more of an identifier of the user plane function, address information of the user plane function, or a tunnel endpoint identifier corresponding to the user plane function.

In a possible implementation, the first network attribute information includes one or more of a data network name, a maximum bit rate, a session type of the user plane function, a service continuity type of the user plane function, or location information of the terminal device.

In a possible implementation, the control plane function establishes a control plane connection to a second entity, and the control plane function sends the information about the user plane function to an access network device.

In a possible implementation, the control plane function corresponds to a plurality of user plane functions, and each user plane function is associated with at least one of a data network or a slice. In this case, the control plane function receives a session establishment request from the terminal device, where the session establishment request includes information about a target data network or a target slice; and the control plane function determines, from the plurality of user plane functions, a target user plane function corresponding to the target data network or the target slice, where the target user plane function is used to provide the terminal device with a network service corresponding to the target data network or the target slice.

According to a third aspect, this application provides a communication apparatus. The apparatus may be a first entity, or may be a chip, a chip system, a processor, or the like that supports the first entity in implementing the foregoing method, or may be a logical module, a unit, or software that can implement all or some functions of the first entity. The communication apparatus may alternatively be a chip system. The communication apparatus includes:
a transceiver unit, configured to receive a first request message, where the first request message is used to request to create or select a user network corresponding to a terminal device, and the first request message includes a user identifier of the terminal device; and a processing unit, configured to create or select a control plane function based on the user identifier, where the control plane function is used to create or select a user plane function corresponding to the control plane function, and the user plane function is used to support a subscription service corresponding to the user identifier.

In a possible implementation, the first request message further includes first information of the user network.

In a possible implementation, the first information of the user network includes an identifier of the user network or a type of the user network.

In a possible implementation, the transceiver unit is configured to receive a second request message from the control plane function, where the second request message is used to request to create or select the user plane function, and the second request message carries first network attribute information; the processing unit is configured to create or select the user plane function based on the first network attribute information; and the transceiver unit is further configured to send information about the user plane function to the control plane function.

In a possible implementation, the transceiver unit is configured to receive a second request message from the control plane function, where the second request message is used to request to create or select the user plane function, the second request message carries second information of the user network, and the second information of the user network includes the identifier of the user network or the type of the user network; the processing unit is configured to create or select the user plane function based on the second information of the user network; and the transceiver unit is configured to send information about the user plane function to the control plane function.

In a possible implementation, the processing unit is further configured to: determine second network attribute information based on the second information of the user network; and create or select the user plane function based on the second network attribute information.

In a possible implementation, the information about the user plane function includes one or more of an identifier of the user plane function, address information of the user plane function, or a tunnel endpoint identifier corresponding to the user plane function.

In a possible implementation, the first network attribute information includes one or more of a data network name, a maximum bit rate, a session type of the user plane function, a service continuity type of the user plane function, or location information of the terminal device.

Alternatively, the second network attribute information includes one or more of a data network name, a maximum bit rate, a session type of the user plane function, or a service continuity type of the user plane function.

In a possible implementation, the processing unit is configured to control, based on the user identifier, the communication apparatus to receive processed user subscription information; and the transceiver unit is configured to send the processed user subscription information to the control plane function, where the processed user subscription information is used to create or select the user plane function.

In a possible implementation, the first request message is one of a non-access stratum message, a registration request message, a service request message, a session establishment message, or a user network creation request message.

In a possible implementation, the first request message is from the terminal device or a second entity.

According to a fourth aspect, this application provides a communication apparatus. The apparatus may be a control plane function, or may be a chip, a chip system, a processor, or the like that supports the control plane function in implementing the foregoing method, or may be a logical module, a unit, or software that can implement all or some functions of a control plane. The communication apparatus may alternatively be a chip system. The communication apparatus includes:
a transceiver unit, configured to obtain a user identifier; and a processing unit, configured to create or select a user plane function corresponding to the control plane function, where the user plane function is used to support a subscription service corresponding to the user identifier.

In a possible implementation, the transceiver unit is configured to obtain user subscription information corresponding to the user identifier; and the processing unit is configured to create or select, based on the user subscription information, the user plane function corresponding to the control plane function.

In a possible implementation, the transceiver unit is configured to receive processed user subscription information corresponding to the user identifier from a first entity; and the processing unit is configured to obtain the user subscription information based on the processed user subscription information.

In a possible implementation, the processing unit is configured to: determine first network attribute information based on the user subscription information; and create or select, based on the first network attribute information, the user plane function corresponding to the control plane function.

In a possible implementation, the processing unit is configured to determine first network attribute information based on the user subscription information; the transceiver unit is configured to send a second request message to the first entity, where the second request message is used to request to create or select the user plane function, and the second request message carries the first network attribute information; and the transceiver unit is further configured to receive information about the user plane function from the first entity.

In a possible implementation, the processing unit is configured to determine second information of a user network, where the second information of the user network includes an identifier of the user network or a type of the user network; and the transceiver unit is configured to send a second request message to a first entity, where the second request message is used to request to create or select the user plane function, and the second request message carries the second information of the user network.

In a possible implementation, the information about the user plane function includes one or more of an identifier of the user plane function, address information of the user plane function, or a tunnel endpoint identifier corresponding to the user plane function.

In a possible implementation, the first network attribute information includes one or more of a data network name, a maximum bit rate, a session type of the user plane function, a service continuity type of the user plane function, or location information of the terminal device.

In a possible implementation, the transceiver unit is configured to: establish a control plane connection to a second entity; and send the information about the user plane function to an access network device.

In a possible implementation, the control plane function corresponds to a plurality of user plane functions, and each user plane function is associated with at least one of a data network or a slice. In this case, the transceiver unit is configured to receive a session establishment request from the terminal device, where the session establishment request includes information about a target data network or a target slice; and the processing unit is configured to determine, from the plurality of user plane functions, a target user plane function corresponding to the target data network or the target slice, where the target user plane function is used to provide the terminal device with a network service corresponding to the target data network or the target slice.

According to a fifth aspect, this application provides a communication apparatus. The communication apparatus may be the first entity in the foregoing method embodiments, or may be a chip disposed in the first entity. The communication apparatus includes a communication interface and a processor, and optionally, further includes a memory. The memory is configured to store a computer program or instructions. The processor is coupled to the memory and the communication interface. When the processor executes the computer program or the instructions, the communication apparatus is enabled to perform the method performed by the first entity in the foregoing method embodiments.

According to a sixth aspect, this application provides a communication apparatus. The communication apparatus may be the control plane function in the foregoing method embodiments, or may be a chip disposed in the control plane function. The communication apparatus includes a communication interface and a processor, and optionally, further includes a memory. The memory is configured to store a computer program or instructions. The processor is coupled to the memory and the communication interface. When the processor executes the computer program or the instructions, the communication apparatus is enabled to perform the method performed by the control plane function in the foregoing method embodiments.

According to a seventh aspect, this application provides a computer-readable storage medium. The computer-readable storage medium is configured to store computer-executable instructions. When the computer-executable instructions are executed, the method performed by the first entity in the method according to the first aspect or the second aspect is implemented, or the method performed by the control plane function in the method according to the first aspect or the second aspect is implemented.

According to an eighth aspect, this application provides a computer program product including a computer program. When the computer program is executed, the method performed by the first entity in the method according to the first aspect or the second aspect is implemented, or the method performed by the control plane function in the method according to the first aspect or the second aspect is implemented.

According to a ninth aspect, this application provides a communication system. The communication system includes the communication apparatuses according to the third aspect and the fourth aspect, or includes the communication apparatuses according to the fifth aspect and the sixth aspect.

### BRIEF DESCRIPTION OF DRAWINGS

FIG. 1a is a schematic of a network system architecture according to an embodiment of this application;

FIG. 1b is a schematic of a structure of a core network according to an embodiment of this application;

FIG. 1c is a schematic of another core network architecture according to an embodiment of this application;

FIG. 2 is a schematic of a structure of a user-centric network according to an embodiment of this application;

FIG. 3 is an interaction diagram of a network function creation method according to an embodiment of this application;

FIG. 4 is a diagram of a correspondence between a control plane function and a user plane function according to an embodiment of this application;

FIG. 5 is an interaction diagram of a network function creation method according to an embodiment of this application;

FIG. 6 is an interaction diagram of another network function creation method according to an embodiment of this application;

FIG. 7 is an interaction diagram of another network function creation method according to an embodiment of this application;

FIG. 8 is a diagram of a structure of a communication apparatus according to an embodiment of this application; and

FIG. 9 is a diagram of a structure of another communication apparatus according to an embodiment of this application.

### DESCRIPTION OF EMBODIMENTS

The following further describes specific embodiments of this application in detail with reference to accompanying drawings.

The terms “first”, “second”, and the like in the specification, claims, and accompanying drawings of this application are used to distinguish between different objects, and are not used to describe a particular sequence. In addition, the terms “including” and “having” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

“An embodiment” mentioned in this specification means that a particular feature, structure, or characteristic described with reference to the embodiment may be included in at least one embodiment of this application. The phrase shown in various locations in the specification does not necessarily refer to a same embodiment, and is not an independent or optional embodiment exclusive from another embodiment. It is explicitly and implicitly understood by a person skilled in the art that embodiments described in the specification may be combined with another embodiment.

In this application, “at least one (item)” means one or more, “a plurality of” means two or more, “at least two (items)” means two or three or more. The term “and/or” is used to describe an association relationship between associated objects and indicates that three relationships may exist. For example, “A and/or B” may indicate the following three cases: Only A exists, only B exists, and both A and B exist, where A and B may be singular or plural. The character “/” generally indicates an “or” relationship between the associated objects. “At least one of the following items (pieces)” or a similar expression thereof refers to any combination of these items, including any combination of singular items (pieces) or plural items (pieces). For example, at least one of a, b, or c may indicate a, b, c, a and b, a and c, b and c, or a, b, and c, where a, b, and c may be singular or plural.

To better understand embodiments of this application, the following first describes a system architecture in embodiments of this application.

The technical solutions in embodiments of this application may be applied to various communication systems, for example, a long term evolution (LTE) system, an LTE frequency division duplex (FDD) system, an LTE time division duplex (TDD) system, a new radio (new radio, NR) system, a 5th generation (5G) system such as a 3rd generation partnership project (3GPP) service-based architecture (SBA), or a communication system evolved after 5G such as a 6th generation (6G) communication system.

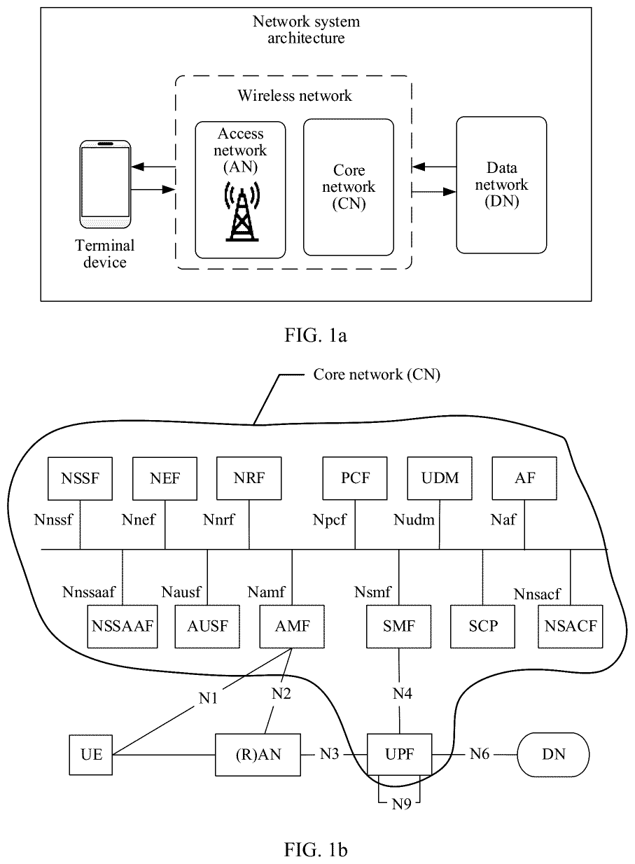

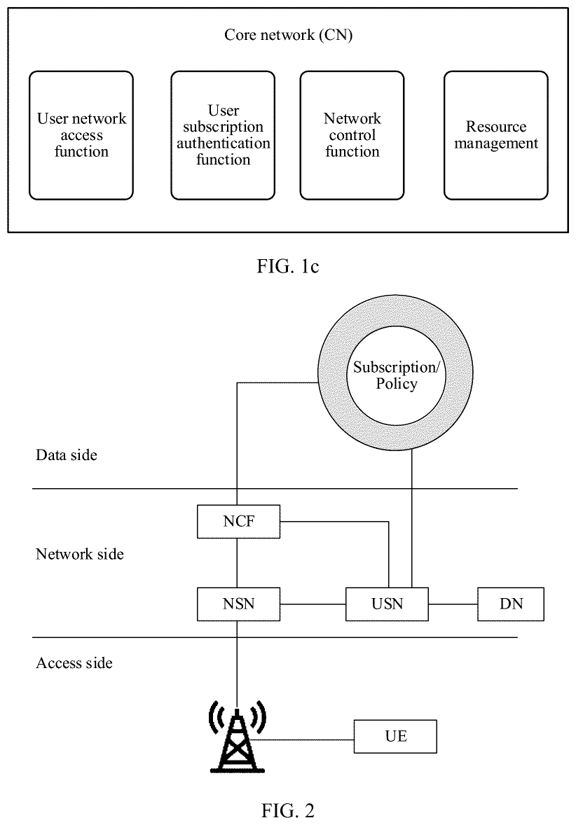

FIG. 1a is a schematic of a network system architecture according to an embodiment of this application. As shown in FIG. 1a, a terminal device may access a wireless network, to obtain a service of an external network (for example, a data network (DN)) through the wireless network, or communicate with another device through the wireless network, for example, communicate with another terminal device. The wireless network includes a (radio) access network ((R)AN) and a core network (CN). The (R)AN (hereinafter described as a RAN) is configured to connect the terminal device to the wireless network, and the CN is configured to manage the terminal device and provide a gateway for communicating with the DN. The following separately describes in detail the terminal device, the RAN, the CN, and the DN in the system architecture in FIG. 1a.

### 1. Terminal Device

The terminal device includes a device that provides voice and/or data connectivity for a user. For example, the terminal device is a device that has wireless sending and receiving functions, and may be deployed on land, including an indoor device or an outdoor device, a handheld device, a wearable device, or a vehicle-mounted device; or may be deployed on a water surface (for example, on a ship); or may be deployed in the air (for example, on an airplane, a balloon, or a satellite). The terminal device may be a mobile phone (mobile phone), a tablet computer (Pad), a computer having wireless sending and receiving functions, a virtual reality (VR) terminal, an augmented reality (AR) terminal, a wireless terminal in industrial control (industrial control), a vehicle-mounted terminal, a wireless terminal in self driving (self driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), a wearable terminal, or the like. An application scenario is not limited in embodiments of this application. The terminal device may also be sometimes referred to as a terminal, user equipment (UE), an access terminal, a vehicle-mounted terminal, a terminal in industrial control, a UE unit, a UE station, a mobile station, a remote station, a remote terminal, a mobile device, a UE terminal, a wireless communication device, a UE agent, a UE apparatus, or the like. The terminal may be fixed or movable. It may be understood that all or some functions of the terminal in this application may alternatively be implemented by using a software function running on hardware, or may be implemented by using an instantiated virtualization function on a platform (for example, a cloud platform).

### 2. RAN

The RAN may include one or more RAN devices (or referred to as access network devices), and an interface between the access network device and the terminal device may be a Uu interface (or referred to as an air interface). Certainly, in communication evolved after 5G, names of these interfaces may remain unchanged, or may be replaced with other names. This is not limited in this application.

The access network device is a node or a device that connects the terminal device to the wireless network. For example, the access network device includes but is not limited to a next generation NodeB (gNB) in a 5G communication system, an evolved NodeB (eNB), a next generation evolved NodeB (ng-eNB), a wireless backhaul device, a radio network controller (RNC), a NodeB (NodeB, NB), a home NodeB ((HeNB) or (HNB)), a baseband unit (baseband unit, BBU), a transmitting and receiving point (TRP), a transmitting point (TP), a mobile switching center, and a device that undertakes a base station function in device-to-device (D2D), vehicle-to-everything (V2X), and machine-to-machine (M2M) communication. The access network device may further include a central unit (CU) and a distributed unit (DU) in a cloud radio access network (C-RAN) system, and a network device in a non-terrestrial network (NTN) communication system, in other words, may be deployed on a high-altitude platform, a satellite, or the like. This is not specifically limited in embodiments of this application.

### 3. CN

The CN may include one or more CN devices (which may also be understood as network element devices or function network elements).

FIG. 1b is a schematic of a structure of a CN according to this application. The CN in FIG. 1b is a schematic of a CN in a 5G network architecture. The CN shown in FIG. 1b includes a plurality of CN devices: a network slice selection function (NSSF), a network exposure function (NEF), a network repository function (NRF), a policy control function (PCF), a unified data management (UDM), an application function (AF), a network control function (NCF), a network slice specific authentication and authorization function (NSSAAF), an authentication server function (AUSF), an AMF, an SMF, a UPF, a service communication proxy (SCP), and a network slice admission control function (NSACF).

The AMF is a control plane function provided by an operator network, and is responsible for access control and mobility management for accessing the operator network by a terminal device, for example, including functions such as mobility status management, allocation of a temporary user identifier, and user authentication and authorization.

The SMF is a control plane function provided by the operator network, and is responsible for managing a PDU session of the terminal device. The PDU session is a channel used for PDU transmission, and the terminal device and the DN need to transmit a PDU to each other through the PDU session. The SMF is responsible for establishment, maintenance, deletion, and the like of the PDU session. The SMF includes session-related functions such as session management (for example, session establishment, modification, and release, including tunnel maintenance between the UPF and the RAN), selection and control of the UPF, service and SSC mode selection, and roaming.

The PCF is a control plane function provided by an operator, includes a user subscription data management function, a policy control function, a charging policy control function, quality of service (QOS) control, and the like, and is mainly configured to provide a PDU session policy for the SMF. The policy may include a charging-related policy, a QoS-related policy, an authorization-related policy, and the like.

The UPF is a gateway provided by the operator, and is a gateway for communication between the operator network and the DN. The UPF includes functions related to a user plane, for example, data packet routing and transmission, packet detection, QoS processing, uplink packet detection, and downlink data packet storage.

The UDM is mainly configured to manage subscription data and authentication data of a user, and perform authentication credit processing, user identifier processing, access authorization, registration/mobility management, subscription management, SMS message management, and the like. In some embodiments, the UDM may further include a unified data repository (UDR). Alternatively, in some other embodiments, a 3GPP SBA in the 5G system may further include a UDR. The UDR is configured to: store and retrieve a PCF policy, store and retrieve structured data for exposure, store user information requested by the application function, and so on.

It should be learned that, in the 5G communication system, function network elements may have names of function network elements shown in FIG. 1b. In a communication system (for example, a 6G communication system) evolved after 5G, function network elements may still have the names of the function network elements shown in FIG. 1b, or may have other names. For example, in the 5G communication system, the policy control network element may be a PCF. In the communication system (for example, the 6G communication system) evolved after 5G, the policy control function may still be the PCF, or may have another name. This is not limited in this application.

In FIG. 1b, Npcf, Nudm, Naf, Namf, Nsmf, N1, N2, N3, N4, and N6 are interface sequence numbers. For meanings of these interface sequence numbers, refer to meanings defined in related standard protocols. This is not limited herein.

FIG. 1c is a schematic of another CN architecture according to this application. In FIG. 1c, a CN includes a user network access function, a user subscription authentication function, a network control function, and a resource management function. The user network access function is used to perform access control on a terminal device; the user subscription authentication function is used to store and manage user subscription information; the network control function is used to manage user network resources, for example, responsible for operations such as generating, changing, and eliminating a user network; and the resource management function is used to store resources of the user network. The user network is configured to provide a network service for one or more users, and may be understood as a core network element that serves UE exclusively. The user network may be a network function that provides a network service for the terminal device, one or a group of virtual machines, a container, a process, or another set of executable resources. The following uses a case in which the user network is a user service node (user service node, USN) as an example for description.

For example, the user network may be a USN. The USN may be understood as integration of a core network control function, and is a core network element that serves UE exclusively. For example, the USN may integrate functions of session management (SM) and/or policy management (PM). Alternatively, the USN may be understood as a digital twin function of UE in the core network, and is a digital model of a real behavior of the UE. For example, functions such as recording service information used by the UE and artificial intelligence (AI) processing are included. Alternatively, the USN may be understood as similar to a cloud server (cloud computer), and UE may orchestrate, on the cloud server, resources provided by the operator, for example, QOS setting and bandwidth allocation of different services. It should be noted that the USN may be integrated into the 5G network architecture shown in FIG. 1b, or may be integrated into the CN architecture shown in FIG. 1c. Alternatively, the USN may exist in a form of a user-centric network (UCN) architecture. In this case, the UCN architecture may be understood as a user-centric network. Refer to a UCN network architecture shown in FIG. 2. The UCN network architecture shown in FIG. 2 includes a network service node (NSN) and a USN. Main functions of the NSN include authentication of access UE and creation and life cycle management of the USN.

The NCF is configured to manage a USN resource in the UCN network architecture, for example, responsible for operations such as generating, changing, and eliminating the USN.

It should be understood that the NSN, the USN, and the NCF in this application are merely examples of names, and should not be considered as a specific limitation thereto. In other words, the NSN, the USN, and the NCF may use other names in another technical solution other than this application, or may be other communication devices with same functions. For example, the NSN may be an access control function, the NCF may be a network resource control or management function, and the USN may be a terminal digital twin function.

It should be noted that: (1) The CN structure shown in FIG. 1c is merely for ease of understanding of the CN, and that each function network element is separately deployed in the CN is merely used as an example. In some possible CN structures, function network elements may be integrated and combined for deployment. For example, the network access function and the user subscription authentication function in FIG. 1c are integrated into a same function network element, or the network access function and the network control function in FIG. 1c are integrated into a same function network element. This is not specifically limited in this application. (2) A core network mentioned in the following part of this application may be a function network element in the core network, or may be integration of several function network elements in the core network, or may be integration of all function network elements in the core network. The core network may be the core network in the 5G communication system shown in FIG. 1b, or may be the core network shown in FIG. 1c, or may be a core network in another possible communication system, for example, an LTE communication system or a communication system evolved after 5G. (3) The foregoing network element or function may be a network element in a hardware device, may be a software function running on dedicated hardware, or may be an instantiated virtualization function on a platform (for example, a cloud platform). Optionally, the foregoing network element or function may be implemented by one device, or may be jointly implemented by a plurality of devices, or may be one function module in one device. This is not specifically limited in embodiments of this application.

### 4. DN

The DN may also be referred to as a packet data network (PDN), and is a network located outside the operator network. The operator network may access a plurality of DNs. Application servers corresponding to a plurality of services may be deployed in the DN, to provide a plurality of possible services for the terminal device.

When the terminal device needs to create a PDU session based on information about a slice and information about a DNN, the terminal device needs to send a PDU session establishment request message to the AMF. The AMF selects, based on the information about the slice, an SMF that serves the slice, and sends the PDU session establishment request message of the terminal device to the SMF. Further, the SMF obtains session subscription information of the terminal device based on the DNN and the information about the slice, and determines a UPF based on information such as the DNN, the information about the slice, an SSC mode, and a location of the terminal device. According to this method, the AMF can obtain session subscription information from user subscription information to create a user plane function only after receiving a session creation requirement of a user each time. Consequently, operations are complex and security is low.

According to a network function creation method provided in this application, a created user plane function can meet all subscription information of a user. In comparison to a manner in which the core network obtains the session subscription information from the user subscription information only after receiving the session creation requirement of the user each time, a manner of creating the user plane function can improve efficiency of providing the user with a network service, and improve system security.

The following further describes, with reference to the accompanying drawings, the network function creation method and a communication apparatus that are provided in this application.

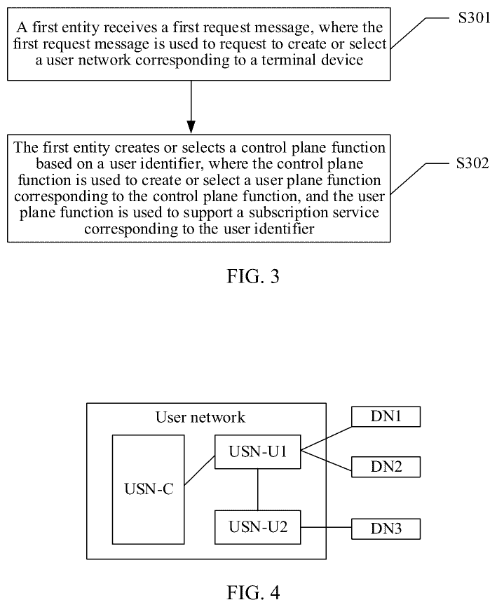

FIG. 3 is a schematic flowchart of a network function creation method according to an embodiment of this application. As shown in FIG. 3, the network function creation method may be performed by a first entity or a chip in the first entity, or may be performed by a control plane function or a chip in the control plane function. FIG. 3 is described by using an example in which the first entity and the control plane function perform the method.

S301: The first entity receives a first request message, where the first request message is used to request to create or select a user network corresponding to a terminal device.

The first request message includes a user identifier of the terminal device. The user identifier includes one or more of information indicating a subscription permanent identifier (for example, an international mobile subscriber identity (IMSI), a subscription permanent identifier (SUPI), or a mobile subscriber international ISDN number (MSISDN)), a user group identifier, a generic public subscription identifier (GPSI), a user temporary identity (for example, a globally unique temporary identity (GUTI)), or an equipment identifier (for example, a permanent equipment identifier (PEI) or an international mobile equipment identity (IMEI)).

The first entity receives the first request message from the terminal device or a second entity, where the first request message is used to create or select the user network corresponding to the terminal device. Specifically, in a possible implementation, when a user has a requirement for creating or selecting the user network, the user may send the first request message to the first entity by using the terminal device. Alternatively, in another possible implementation, the user sends, to the second entity by using the terminal device, a message used to create or select the user network. Further, the second entity sends the first request message to the first entity based on the message from the terminal device.

In a possible implementation, the first request message may be one of a non-access stratum message, a registration request message, a service request message, a session establishment message, or a user network creation request message.

In a possible implementation, the first request message further includes first information of the user network. The first information of the user network includes an identifier of the user network or a type of the user network. The identifier of the user network indicates a specific user network. For example, a USN identifier (USN ID) indicates a specific USN node. The type of the user network indicates a service (or service) type of the user network. For example, the type of the user network includes but is not limited to one or more of an internet of things service network, a high-bandwidth service network, a personal network service network, and a virtual service network. It should be understood that a virtual network service may be a virtual terminal service provided for a terminal, for example, a cloud phone, a cloud computer, or a digital twin service.

In this implementation, the first entity may create a specific user network based on the first request message, so that the created user network better meets a user requirement.

It should be noted that: (1) Entities (including the first entity and the second entity) mentioned in this application may be understood as function network elements in a CN. The first entity is configured to perform management (which is alternatively understood as an operation) on the user network. For example, the first entity may be a logical network element newly added in FIG. 1b, or may be integrated into an existing network function in FIG. 1b as a logical function. The first entity may be a network control function in FIG. 1c. The first entity may be an NCF network element in FIG. 2. The second entity is configured to connect the terminal device to the user network or the CN. For example, the second entity may be an AMF network element in FIG. 1b; the second entity may be a user network access function in FIG. 1c; and the second entity may be an NSN network element in FIG. 2. (2) The user network refers to a network function (network function, NF) that provides a network service (including but not limited to one or more of data download, data access, and a call) for the terminal device, one or a group of virtual machines, a container, a process, or another set of executable resources. In other words, the user network may be a user service function entity or another user service network function. For example, the user network may be a USN network element or a USN function entity. (3) The user network may be divided into a control plane function and a user plane function. The user plane function is used to: forward user plane data between the user plane function and the terminal device; or perform traffic statistics collection. The control plane function is used to process control plane signaling (including session management signaling, policy management signaling, or the like) exchanged between the control plane function and the terminal device, and the control plane function may further control the user plane function through session management.

S302: The first entity creates or selects the control plane function based on the user identifier, where the control plane function is used to create or select the user plane function corresponding to the control plane function, and the user plane function is used to support a subscription service corresponding to the user identifier.

The first entity creates (or selects) the control plane function corresponding to the user identifier based on the user identifier in the first request message. Further, the first entity or the control plane function creates (or selects) the user plane function corresponding to the control plane function, and the user plane function is used to support the subscription service corresponding to the user identifier.

In a possible implementation, the control plane function corresponds to one or more user plane functions, and the one or more user plane functions may support all subscription services corresponding to the user identifier. For example, subscription services corresponding to a user A includes a network service of DN 1, a network service of DN 2, and a network service of DN 3. In this case, for a correspondence between a control plane function and a user plane function of the user A, refer to FIG. 4. In FIG. 4, the control plane function (USN-C in FIG. 4) of the user A corresponds to two user plane functions (USN-U1 and USN-U2 in FIG. 4). USN-U1 is configured to transmit user plane data of DN 1 and DN 2 to a terminal device of the user A, and USN-U1 and USN-U2 are configured to transmit user plane data of DN 3 to the terminal device of the user A.

In a possible implementation, a specific operation of creating the control plane function by the first entity includes: If the first entity has an available network functions virtualization (NFV) resource (which is alternatively understood as that the NFV resource is sufficient), the first entity creates the control plane function based on the request message and the available NFV resource. Alternatively, the first entity has a capability of managing a plurality of control plane functions, and the plurality of control plane functions are pre-created by an operator and may be controlled by the first entity. However, the plurality of pre-created control plane functions are not associated with a user (which may be understood as an inactive state). When the first entity needs to create a control plane function for a user, the first entity may select a corresponding pre-created control plane function based on a requirement of the user, and associate and bind a user identifier with the selected control plane function (which may be understood as that the pre-created control plane function is activated).

In a possible implementation, a specific operation of selecting the control plane function by the first entity includes: The first entity has created (or associated) a control plane function for one or more users. When obtaining a request of a new user, if the first entity determines that a control plane function requested by the new user has been created, the first entity may associate the new user with the created control plane function.

After the first entity creates the control plane function, the control plane function is used to process control plane signaling corresponding to the user identifier. After the first entity selects the control plane function, in addition to processing the control plane signaling corresponding to the user identifier, the control plane function may further process control plane signaling corresponding to another user identifier. For example, the control plane function processes control plane signaling corresponding to a group of users (for example, a home user group).

The following describes in detail the network function creation method provided in this application with reference to the following three scenarios (a scenario 1, a scenario 2, and a scenario 3). Scenario 1: The first entity can perceive user subscription information. Scenario 2: The first entity does not perceive user subscription information, and the control plane function creates (or selects) the user plane function. Scenario 3: The first entity does not perceive user subscription information, and the first entity creates (or selects) the user plane function.

For ease of understanding of the technical solutions provided in this application, the following first describes creation or selection of the user plane function. The following uses a manner of creating or selecting the user plane function by the control plane function as an example for description. For a manner of creating or selecting the user plane function by the first entity, refer to the same manner.

In a possible implementation, a specific operation of creating the user plane function includes: The user plane function may be a service provider, and provides a service for forwarding a data packet. The control plane function uses network attribute information as a service configuration file, and sends the network attribute information to the user plane function. The user plane function establishes a corresponding connection configuration based on the network attribute information. For example, the user plane function establishes a link to an access network device connected to a user, and the user plane function establishes a link to a DN interface, so that data is transmitted between the access network device and the DN interface by using the user plane function. In addition, it is determined that an upper limit of a data transmission rate of these links is a maximum bit rate provided by the control plane. Another parameter configuration such as a session type of the user plane function or a service continuity type of the user plane function is also set for a link based on a parameter provided by the control plane function.

In another possible implementation, a specific operation of creating the user plane function includes: The control plane function and the user plane function are implemented by a same node. In this case, a creation process may be that the control plane function establishes, based on a network attribute, a connection to an access network device and a connection to a DN that can be accessed by a user, and a maximum transmission rate of the user plane function that can be used by the user is limited based on a maximum bit rate.

In a possible implementation, a specific operation of selecting the user plane function includes: The user plane function may be a resource pool, and the resource pool includes a plurality of entities that can perform the user plane function. The control plane function selects, based on a current location of a user, a control plane entity that can be connected to a current location area of the user, and selects, based on information about DNs that can be connected to the user, a user plane function that can access the DNS.

In another possible implementation, a specific operation of selecting the user plane function includes: The user plane function may be a resource pool, the resource pool includes a plurality of entities that can perform the user plane function, and the user plane function entity may be associated with a user group identifier. When the control plane function obtains a user identifier (where the user identifier includes the user group identifier), the control plane function selects, based on the user identifier (where the user identifier includes the user group identifier), a user plane function associated with the user group identifier.

Based on the foregoing method for creating or selecting the user plane function, for some DNs, one user plane entity can provide services, and for some DNs, a plurality of user plane entities may be needed to connect the access network device of the user and the DN interface. In addition, a transmission rate upper limit of the user plane function is set based on another parameter in the network attribute, for example, a maximum bit rate, and a user plane function that can support the foregoing parameters is selected based on the session type of the user plane function or the service continuity type of the user plane function.

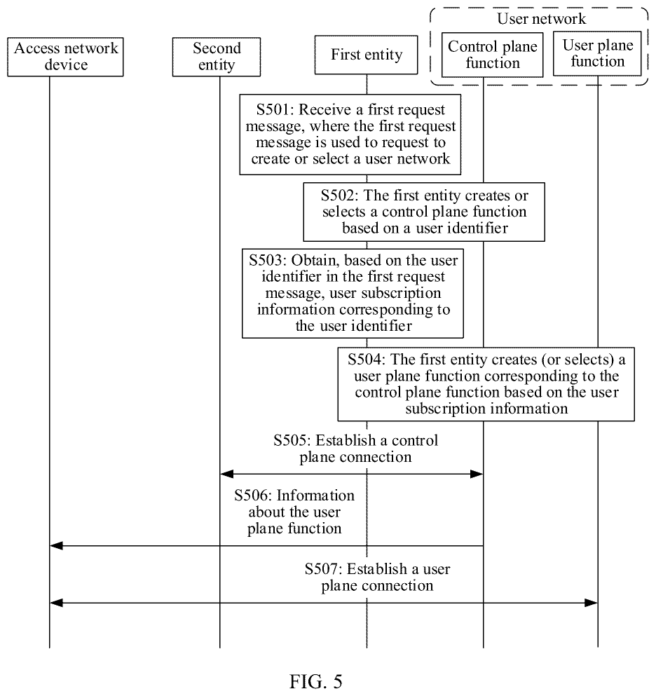

For the scenario 1 (a scenario in which the first entity can perceive the user subscription information), refer to FIG. 5. FIG. 5 is an interaction diagram of another network function creation method according to an embodiment of this application. As shown in FIG. 5, the network function creation method may be performed by a first entity or a chip in the first entity, or may be performed by a control plane function or a chip in the control plane function. FIG. 5 is described by using an example in which the first entity and the control plane function perform the method.

S501: The first entity receives a first request message, where the first request message is used to request to create or select a user network corresponding to a terminal device.

S502: The first entity creates or selects the control plane function based on a user identifier.

For specific implementations of S501 and S502, refer to the descriptions of the specific implementations of S301 and S302. Details are not described herein again.

S503: The first entity obtains, based on the user identifier in the first request message, user subscription information corresponding to the user identifier.

The first entity obtains, based on the user identifier, the user subscription information corresponding to the user identifier from a third entity (for example, one or more of a DN, a PCF, a UDM network element, or a UDR) that stores the user subscription information corresponding to the user identifier.

The user subscription information includes one or more of the following information: access-related subscription information or policy information (for example, an access control function, location control, and time control); session-related subscription information or policy information (for example, an internet service function, a service provided by a specific operator, a slice service, and a customized network function service); and data transmission-related subscription information or policy information (for example, a QoS parameter, a data packet loss rate, a latency, bandwidth, and a network speed). It may be understood that the user subscription information indicates a network capability of a user plane network function, and the network capability includes one or more of the following information: a mobility management (MM) capability, an SM capability, or a PM capability.

In a possible implementation, before the first entity obtains the user subscription information from the third entity, the first entity may verify the terminal device based on the user identifier. The first entity sends a request message to the third entity to obtain the user subscription information only when verifying that the terminal device is an authorized terminal device (that is, the terminal device is a real terminal device registered by a user). Alternatively, in another implementation, after the third entity receives, from the first entity, a request message for obtaining the user subscription information, the third entity performs authentication on an identity of the first entity based on the request message, and sends the user subscription information to the first entity only after determining the identity of the first entity (that is, determining that the first entity has an operation permission to obtain the user subscription information). In this implementation, security of the subscription information or the policy information of the terminal device can be improved, and user privacy can be protected.

S504: The first entity creates (or selects) a user plane function corresponding to the control plane function based on the user subscription information.

The first entity determines, based on the user subscription information, a network attribute (or understood as a network parameter) of the user plane function, and creates (or selects) the user plane function corresponding to the control plane function based on the network attribute of the user plane function. In other words, a network capability of the user plane function corresponding to the control plane function matches the user subscription information, and the user plane function can support all subscription services corresponding to the user subscription information.

In a possible implementation, when the first request message includes first information of the user network, the first entity may further determine a network attribute of the user plane function based on the first information of the user network, and create (or select) the user plane function corresponding to the control plane function based on the network attribute of the user plane function. For example, the first information of the user network is a type of the user network. In this case, the first entity obtains, from a local configuration based on the type of the user network, a network attribute (or understood as a network parameter) of a user plane function associated with the type of the user network, and creates (or selects) the user plane function corresponding to the control plane function based on the network attribute of the user plane function.

In a possible implementation, the first request message includes first information of the user network, and the first entity may determine a network attribute of the user plane function based on the first information of the user network and the user subscription information, and create (or select) the user plane function corresponding to the control plane function based on the network attribute of the user plane function.

It should be noted that the user plane function and the control plane function that are created by using the method provided in FIG. 5 may be created simultaneously, or the user plane function and the control plane function may be integrated into one function network element (where the function network element is the foregoing user network, that is, the control plane function and the user plane function are integrated).

S505: The control plane function establishes a control plane connection to a second entity.

After the first entity creates the control plane function based on the user identifier, the first entity sends information about the second entity to the control plane function, so that the control plane function establishes the control plane connection to the second entity based on the information about the second entity. Alternatively, after the first entity creates the control plane function based on the user identifier, the first entity sends information about the control plane function to the second entity, so that the second entity establishes a control plane connection to the control plane function based on the information about the control plane function. In this implementation, a core network (including the first entity, the second entity, another entity connected to the first entity, or another entity connected to the second entity) may be enabled to control and manage the user network.

The information about the second entity is used to address the second entity, and may include an identifier of the second entity or an address of the second entity. The information about the control plane function is used to address the control plane function, and may include an identifier of the control plane function or an address of the control plane function.

S506: The control plane function sends information about the user plane function to an access network device, and correspondingly, the access network device receives the information about the user plane function from the control plane function.

After creating (or selecting) the user plane function corresponding to the control plane function, the control plane function sends the information about the user plane function to the access network device, where the information about the user plane function is used to address the user plane function. The information about the user plane function includes one or more of an identifier of the user plane function, address information of the user plane function, or a tunnel endpoint identifier corresponding to the user plane function.

Optionally, after creating (or selecting) the user plane function corresponding to the control plane function, the control plane function sends information about the access network device to the user plane function. The information about the access network device is used to address the access network device, and includes but is not limited to an identifier of the access network device or an address of the access network device.

S507: The user plane function establishes a user plane connection to the access network device.

According to a specific implementation of S506, a specific implementation in which the user plane function establishes the user plane connection to the access network device may be that the access network device may establish the user plane connection to the user plane function based on the information about the user plane function, or may be that the user plane function establishes the user plane connection to the access network device based on the information about the access network device.

In a possible implementation, the control plane function corresponds to a plurality of user plane functions, and each user plane function is associated with at least one of a data network or a slice. In this case, the control plane function receives a session establishment request from the terminal device, where the session establishment request includes information about a target data network or a target slice. Further, the control plane function determines, from the plurality of user plane functions corresponding to the control plane function, a target user plane function corresponding to the target data network or the target slice. The target user plane function is used to provide the terminal device with a network service corresponding to the target data network or the target slice. The user plane function created by using this method can support all subscription services corresponding to a user. When the terminal device has a request for any service in the subscription services of the user, the terminal device does not need to re-obtain the user subscription information to create the user plane function, so that efficiency of providing the terminal device with the user subscription service can be improved.

For example, for a correspondence between a control plane function and a user plane function of a user A, refer to FIG. 4. The control plane function receives a session establishment request from the user A, where the session establishment request includes an identifier of DN 1 (that is, a target data network). Further, the control plane function determines, from a plurality of user plane functions (USN-U1 and USN-U2 in FIG. 4), a user plane function corresponding to DN 1, that is, USN-U1. USN-C controls USN-U1 to establish a session based on the session establishment request.

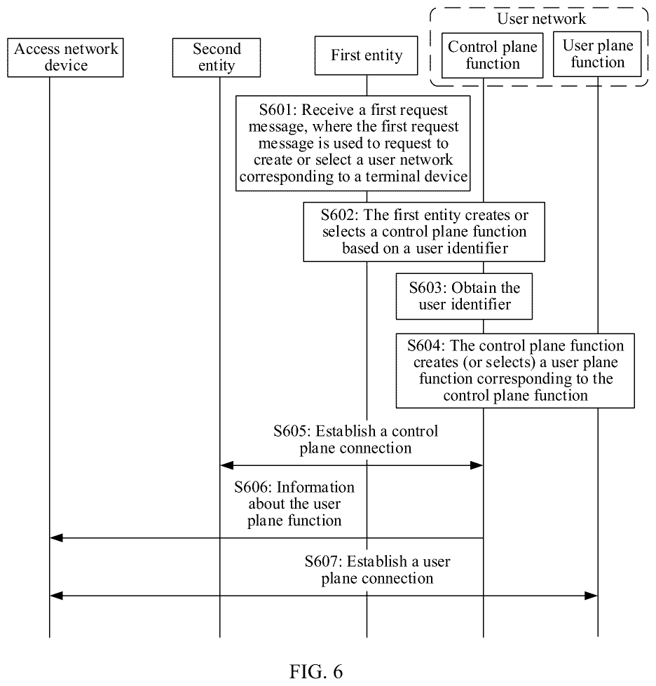

For the scenario 2 (where the control plane function creates (or selects) the user plane function), refer to FIG. 6. FIG. 6 is an interaction diagram of another network function creation method according to an embodiment of this application. As shown in FIG. 6, the network function creation method may be performed by a first entity or a chip in the first entity, or may be performed by a control plane function or a chip in the control plane function. FIG. 6 is described by using an example in which the first entity and the control plane function perform the method.

S601: The first entity receives a first request message, where the first request message is used to request to create or select a user network corresponding to a terminal device. S602: The first entity creates or selects the control plane function based on a user identifier.

For specific implementations of S601 and S602, refer to the descriptions of the specific implementations of S301 and S302. Details are not described herein again.

S603: The control plane function obtains the user identifier.

After the first entity creates (or selects) the control plane function, the control plane function may receive the user identifier from the first entity. Alternatively, when the first entity creates the control plane function based on the user identifier, the first entity binds the control plane function to the user identifier. In other words, it may be understood that the control plane function is created, and it may be determined that the control plane function knows the user identifier.

S604: The control plane function creates (or selects) a user plane function corresponding to the control plane function.

The control plane function creates (or selects) the user plane function corresponding to the control plane function based on the user identifier, so that the user plane function can support a subscription service corresponding to the user identifier.

In a possible implementation, the control plane function obtains user subscription information corresponding to the user identifier, and creates (or selects) the user plane function corresponding to the control plane function based on the user subscription information. In this implementation, a network capability of the created user plane function matches the user subscription information.

The following first describes a manner in which the control plane function obtains the user subscription information corresponding to the user identifier. The following two manners may be specifically included.

Manner 1: The control plane function obtains, based on the user identifier, the user subscription information corresponding to the user identifier from a third entity (for example, one or more of a DN, a PCF, a UDM network element, or a UDR) that stores the user subscription information corresponding to the user identifier.

Manner 2: The control plane function receives processed user subscription information corresponding to the user identifier from the first entity. Further, the control plane function obtains the user subscription information based on the processed user subscription information.

The processed user subscription information may be understood as encrypted user subscription information or user subscription information obtained by using a container. In other words, the first entity obtains the processed user subscription information from the third entity (for example, one or more of the DN, the PCF, the UDM network element, or the UDR) by using the container or in another encryption manner, and sends the processed user subscription information to the control plane function. The control plane function performs restoration processing (for example, decryption processing) on the processed user subscription information, to obtain the user subscription information.

After the control plane function obtains the user subscription information, the control plane function may determine first network attribute information based on the user subscription information. Further, the control plane function creates (or selects) the user plane function corresponding to the control plane function based on the first network attribute information. The first network attribute information includes one or more of a data network name, a maximum bit rate, a session type of the user plane function, a service continuity type of the user plane function, or location information of the terminal device. The data network name may be an identifier of a data network, for example, a DNN. The session type of the user plane function indicates a type of a data packet transmitted by a session, and the type of the data packet includes an internet protocol (IP) data packet and a non-IP data packet. The service continuity type of the user plane function indicates a switching method for ensuring transmission continuity of user plane data. For example, the switching method includes one or more of SSC Mode1, SSC Mode2, or SSC Mode3.

Optionally, when the first request message includes first information of the user network, after the first entity creates the control plane function, the first entity sends the first information of the user network to the control plane function. Further, the control plane function determines a network attribute of the user plane function based on the first information of the user network, and creates (or selects) the user plane function corresponding to the control plane function based on the network attribute. For example, the first information of the user network is a type of the user network. In this case, the control plane function obtains, from another function network element (a function network element other than the control plane function) based on the type of the user network, a network attribute of a user plane function associated with the type of the user network, and creates (or selects) the user plane function corresponding to the control plane function based on the network attribute of the user plane function.

Optionally, when the first request message includes first information of the user network, after the first entity creates the control plane function, the first entity sends the first information of the user network to the control plane function. Further, the control plane function determines a network attribute of the user plane function based on the first information of the user network and the user subscription information, and creates (or selects) the user plane function corresponding to the control plane function based on the network attribute.

S605: The control plane function establishes a control plane connection to a second entity.

S606: The control plane function sends information about the user plane function to an access network device.

S607: The user plane function establishes a user plane connection to the access network device.

For specific implementations of S605 to S607, refer to the descriptions of the specific implementations of S505 to S507. Repeated content is not described herein again.

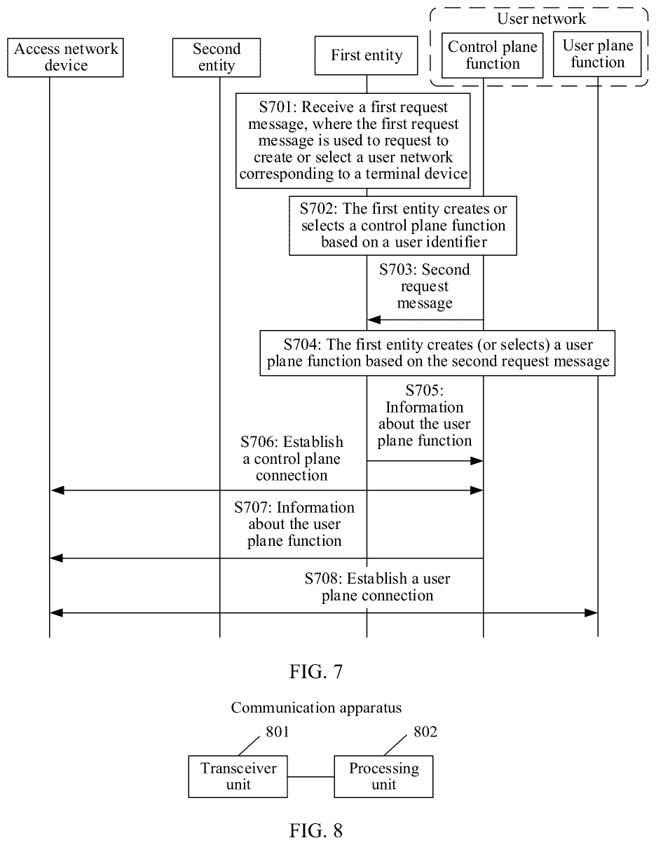

For the scenario 3 (where the first entity does not perceive the user subscription information, and the first entity creates (or selects) the user plane function), refer to FIG. 7. FIG. 7 is an interaction diagram of another network function creation method according to an embodiment of this application. As shown in FIG. 7, the network function creation method may be performed by a first entity or a chip in the first entity, or may be performed by a control plane function or a chip in the control plane function. FIG. 7 is described by using an example in which the first entity and the control plane function perform the method.

S701: The first entity receives a first request message, where the first request message is used to request to create or select a user network corresponding to a terminal device.

S702: The first entity creates or selects the control plane function based on a user identifier.

For specific implementations of S701 and S702, refer to the descriptions of the specific implementations of S301 and S302. Details are not described herein again.

S703: The first entity receives a second request message from the control plane function, and correspondingly, the control plane function sends the second request message to the first entity.

When the control plane function has a requirement for creating (or selecting) a user plane function, the control plane function sends the second request message to the first entity, where the second request message is used to request to create (or select) the user plane function.

The following describes content of the second request message sent by the control plane function to the first entity in detail in the following two cases.

Case 1: The second request message carries first network attribute information.

Specifically, after the first entity creates or selects the control plane function, the control plane function obtains the user identifier, and obtains user subscription information based on the user identifier. Further, the control plane function may determine the first network attribute information based on the user subscription information. The control plane function sends the second request message to the first entity, where the second request message is used to request to create (or select) the user plane function, and the second request message carries the first network attribute information.

For a specific implementation in which the control plane function obtains the user identifier, refer to the descriptions of the specific implementation in S603. For a specific implementation in which the control plane function obtains the user subscription information, refer to Manner 1 and Manner 2 in which the control plane function obtains the user subscription information corresponding to the user identifier in S604. Repeated content is not described herein again.

Case 2: The second request message carries second information of the user network.

In other words, the control plane function determines the second information of the user network, where the second information of the user network includes but is not limited to an identifier of the user network or a type of the user network. For specific explanations of the identifier of the user network and the type of the user network, refer to the specific explanations of the identifier of the user network and the type of the user network in S301. Details are not described herein again. Further, the control plane function sends the second request message to the first entity, where the second request message is used to request to create (or select) the user plane function, and the second request message carries the second information of the user network.

The following describes in detail a specific manner in which the control plane function determines the second information of the user network.

In a possible implementation, when the first request message includes the user identifier and first information of the user network, after the first entity creates the control plane function based on the user identifier, the first entity sends the first information of the user network to the control plane function. In this case, the control plane function determines the second information of the user network based on the first information of the user network.

For example, a user network type of a user network identifier USN1 is a user network of a vehicle to everything (V2X) service. In this case, after the first entity creates the control plane function based on the user identifier, the first entity sends the user network identifier (that is, USN1) to the control plane function. Further, the control plane function determines, based on the user network identifier (that is, USN1), that the type of the user network is the user network of the V2X service. The control plane function sends the second request message to the first entity, where the second request message carries an identifier of a V2X service type, to request the first entity to create (or select) a user network of the V2X service.

In another possible implementation, when the first request message includes the user identifier and first information of the user network, after the first entity creates the control plane function based on the user identifier and the first information of the user network, the control plane function determines the second information of the user network based on attribute information of the control plane function. The attribute information of the control plane function includes but is not limited to a service (or service) type of the control plane function.

For example, a first message received by the first entity is: creating a user network (that is, the first information of the user network in the first request message) of a V2X service for a user A (that is, the user identifier in the first request message). The first entity creates the control plane function, where the control plane function is associated with the V2X service (that is, attribute information of the control plane function is a V2X service type). In this case, the control plane function determines that the second information of the user network is the V2X service type. The control plane function sends the second request message to the first entity, where the second request message carries an identifier of the V2X service type, to request the first entity to create (or select) a user network of the V2X service.

S704: The first entity creates (or selects) the user plane function based on the second request message.

The first entity creates (or selects) the user plane function based on content in the second request message. The following specifically describes, based on the two cases in S703, that the first entity creates (or selects) the user plane function.

Case 1 (which corresponds to Case 1 in S703): The second request message carries the first network attribute information.

In this case, the first entity creates (or selects) the user plane function based on the first network attribute information. In other words, a configuration parameter of the user plane function is consistent with a configuration parameter in the first network attribute information.

Case 2 (which corresponds to Case 2 in S703): The second request message carries the second information of the user network.

In this case, the first entity determines second network attribute information based on the second information of the user network, and creates (or selects) the user plane function based on the second network attribute information. In other words, a configuration parameter of the user plane function is consistent with a configuration parameter in the second network attribute information. The second network attribute information includes one or more of a data network name, a maximum bit rate, a session type of the user plane function, or a service continuity type of the user plane function.

For example, a plurality of correspondences between user network types and network attribute information are configured in the first entity. An internet of things service user network corresponds to network attribute information a, and a V2X service user network corresponds to network attribute information b. In this case, if the second information of the user network received by the first entity is the V2X service user network, the first entity determines that the second network attribute information is the network attribute information b. Further, the first entity creates (or selects) the V2X service user network based on the network attribute information b.

S705: The first entity sends information about the user plane function to the control plane function, and correspondingly, the control plane function receives the information about the user plane function from the first entity.

After the first entity creates (or selects) the user plane function based on the second request message of the control plane function, the first entity sends the information about the user plane function to the control plane function, where the information about the user plane function is used to address the user plane function.

In a possible implementation, the information about the user plane function includes one or more of an identifier of the user plane function, address information of the user plane function, or a tunnel endpoint identifier corresponding to the user plane function.

It should be noted that the first entity configured to perform S703 to S705 and the first entity configured to perform S701 and S702 may be the same entity; or the first entity configured to perform S703 to S705 and the first entity configured to perform S701 and S702 may be different entities (which may be understood as entities of one type, but not the same entity). This is not specifically limited in this application.

S706: The control plane function establishes a control plane connection to a second entity.

S707: The control plane function sends the information about the user plane function to an access network device, and correspondingly, the access network device receives the information about the user plane function from the control plane function.

S708: The user plane function establishes a user plane connection to the access network device.

For specific implementations of S706 to S708, refer to the descriptions of the specific implementations of S505 to S507. Repeated content is not described herein again.

It can be learned that, in a process in which the network function creation method described in FIG. 7 or FIG. 6 is performed, the first entity does not perceive (or it is understood that the first entity cannot know) specific content of the user subscription information, so that security of the user subscription information is improved. In a process in which the network function creation method described in FIG. 5 and FIG. 6 is performed, after the first entity creates the control plane function, the first entity (in the network function creation method described in FIG. 5) or the control plane function (in the network function creation method described in FIG. 6) creates the user plane function, so that transmission resource consumption can be reduced. In addition, according to the network function creation method described in FIG. 5, the first entity creates the control plane function and the user plane function, and the first entity may create the control plane function and the user plane function simultaneously, so that network function creation efficiency can be improved.

In a process in which the network function creation method described in FIG. 7 or FIG. 6 is performed, the user plane function and the control plane function may be integrated (in other words, the control plane function and the user plane function are the same function entity), or the user plane function and the control plane function may be separately deployed in a communication system (in other words, the control plane function and the user plane function are different function entities). This is not specifically limited in this application. A manner in which the user plane function and the control plane function are separately deployed in the communication system is more flexible.

FIG. 8 is a diagram of a structure of a communication apparatus according to an embodiment of this application. The communication apparatus shown in FIG. 8 may be configured to implement some or all functions of the first entity in the embodiments corresponding to the network function creation method, or the communication apparatus shown in FIG. 8 may be configured to implement some or all functions of the control plane function in the embodiments corresponding to the network function creation method.

In an embodiment, the communication apparatus shown in FIG. 8 may be configured to implement some or all functions of the first entity in the method embodiments described in any one of FIG. 3 and FIG. 5 to FIG. 7. The apparatus may be a terminal device, an apparatus in the first entity, or an apparatus that can be used together with the first entity. The communication apparatus may alternatively be a chip system. The communication apparatus shown in FIG. 8 may include a transceiver unit 801 and a processing unit 802, where
the transceiver unit 801 is configured to receive a first request message, where the first request message is used to request to create or select a user network corresponding to a terminal device, and the first request message includes a user identifier of the terminal device; and the processing unit 802 is configured to create or select a control plane function based on the user identifier, where the control plane function is used to create or select a user plane function corresponding to the control plane function, and the user plane function is used to support a subscription service corresponding to the user identifier.

In a possible implementation, the first request message further includes first information of the user network.

In a possible implementation, the first information of the user network includes an identifier of the user network or a type of the user network.

In a possible implementation, the transceiver unit 801 is configured to receive a second request message from the control plane function, where the second request message is used to request to create or select the user plane function, and the second request message carries first network attribute information; the processing unit 802 is configured to create or select the user plane function based on the first network attribute information; and the transceiver unit is further configured to send information about the user plane function to the control plane function.

In a possible implementation, the transceiver unit 801 is configured to receive a second request message from the control plane function, where the second request message is used to request to create or select the user plane function, the second request message carries second information of the user network, and the second information of the user network includes the identifier of the user network or the type of the user network; the processing unit 802 is configured to create or select the user plane function based on the second information of the user network; and the transceiver unit 801 is configured to send information about the user plane function to the control plane function.

In a possible implementation, the processing unit 802 is further configured to: determine second network attribute information based on the second information of the user network; and create or select the user plane function based on the second network attribute information.

In a possible implementation, the information about the user plane function includes one or more of an identifier of the user plane function, address information of the user plane function, or a tunnel endpoint identifier corresponding to the user plane function.

In a possible implementation, the first network attribute information includes one or more of a data network name, a maximum bit rate, a session type of the user plane function, a service continuity type of the user plane function, or location information of the terminal device.

Alternatively, the second network attribute information includes one or more of a data network name, a maximum bit rate, a session type of the user plane function, a service continuity type of the user plane function, or location information of the terminal device.

In a possible implementation, the processing unit 802 is configured to control, based on the user identifier, the communication apparatus to receive processed user subscription information; and the transceiver unit 801 is configured to send the processed user subscription information to the control plane function, where the processed user subscription information is used to create or select the user plane function.

In a possible implementation, the first request message is one of a non-access stratum message, a registration request message, a service request message, a session establishment message, or a user network creation request message.

In a possible implementation, the first request message is from the terminal device or a second entity.

For more detailed descriptions of the transceiver unit 801 and the processing unit 802, refer to related descriptions of the first entity in the foregoing method embodiments. Details are not described herein again.

In an embodiment, the communication apparatus shown in FIG. 8 may be configured to implement some or all functions of the control plane function in the method embodiments described in any one of FIG. 3 and FIG. 5 to FIG. 7. The apparatus may be a control plane function, an apparatus in the control plane function, or an apparatus that can be used together with the control plane function. The communication apparatus may alternatively be a chip system. The communication apparatus shown in FIG. 8 may include a transceiver unit 801 and a processing unit 802, where
the transceiver unit 801 is configured to obtain a user identifier; and the processing unit 802 is configured to create or select a user plane function corresponding to the control plane function, where the user plane function is used to support a subscription service corresponding to the user identifier.

In a possible implementation, the transceiver unit 801 is configured to obtain user subscription information corresponding to the user identifier; and the processing unit 802 is configured to create or select, based on the user subscription information, the user plane function corresponding to the control plane function.

In a possible implementation, the transceiver unit 801 is configured to receive processed user subscription information corresponding to the user identifier from a first entity; and the processing unit 802 is configured to obtain the user subscription information based on the processed user subscription information.

In a possible implementation, the processing unit 802 is configured to: determine first network attribute information based on the user subscription information; and create or select, based on the first network attribute information, the user plane function corresponding to the control plane function.

In a possible implementation, the processing unit 802 is configured to determine first network attribute information based on the user subscription information; the transceiver unit 801 is configured to send a second request message to the first entity, where the second request message is used to request to create or select the user plane function, and the second request message carries the first network attribute information; and the transceiver unit 801 is further configured to receive information about the user plane function from the first entity.

In a possible implementation, the processing unit 802 is configured to determine second information of a user network, where the second information of the user network includes an identifier of the user network or a type of the user network; and the transceiver unit 801 is configured to send a second request message to a first entity, where the second request message is used to request to create or select the user plane function, and the second request message carries the second information of the user network.

In a possible implementation, the information about the user plane function includes one or more of an identifier of the user plane function, address information of the user plane function, or a tunnel endpoint identifier corresponding to the user plane function.

In a possible implementation, the first network attribute information includes one or more of a data network name, a maximum bit rate, a session type of the user plane function, a service continuity type of the user plane function, or location information of a terminal device.

In a possible implementation, the transceiver unit 801 is configured to: establish a control plane connection to a second entity; and send the information about the user plane function to an access network device.

In a possible implementation, the control plane function corresponds to a plurality of user plane functions, and each user plane function is associated with at least one of a data network or a slice. In this case, the transceiver unit 801 is configured to receive a session establishment request from the terminal device, where the session establishment request includes information about a target data network or a target slice; and the processing unit 802 is configured to determine, from the plurality of user plane functions, a target user plane function corresponding to the target data network or the target slice, where the target user plane function is used to provide the terminal device with a network service corresponding to the target data network or the target slice.

For more detailed descriptions of the transceiver unit 801 and the processing unit 802, refer to related descriptions of the control plane function in the foregoing method embodiments. Details are not described herein again.

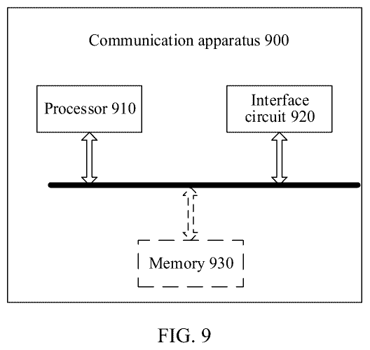

FIG. 9 is a diagram of a structure of a communication apparatus 900 according to this application. The communication apparatus 900 includes a processor 910 and an interface circuit 920. The processor 910 and the interface circuit 920 are coupled to each other. It may be understood that the interface circuit 920 may be a transceiver or an input/output interface. Optionally, the communication apparatus 900 may further include a memory 930, configured to: store instructions executed by the processor 910, store input data needed by the processor 910 to run the instructions, or store data generated after the processor 910 runs the instructions.

When the communication apparatus 900 is configured to implement the method in the foregoing method embodiments, the processor 910 is configured to perform a function of the processing unit 802, and the interface circuit 920 is configured to perform a function of the transceiver unit 801.

When the communication apparatus is a chip used in a first entity, the first entity chip implements a function of the first entity in the foregoing method embodiments. The first entity chip receives information from another network element, or the first entity chip sends information to another entity.

When the communication apparatus is a chip used in a control plane function, the control plane function chip implements a function of the control plane function in the foregoing method embodiments. The control plane function chip receives information from another network element (or entity), or the control plane function chip sends information to another network element (or entity).

It may be understood that, the processor in embodiments of this application may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any regular processor.

The method steps in embodiments of this application may be implemented by hardware, or may be implemented by a processor executing software instructions. The software instructions may include a corresponding software module. The software module may be stored in a random access memory (RAM), a flash memory, a read-only memory (ROM), a programmable read-only memory (PROM), an erasable programmable read-only memory (EPROM), an electrically erasable programmable read-only memory (EEPROM), a register, a hard disk, a removable hard disk, a CD-ROM, or any other form of storage medium well-known in the art. For example, a storage medium is coupled to a processor, so that the processor can read information from the storage medium and write information into the storage medium. Certainly, the storage medium may be a component of the processor. The processor and the storage medium may be located in an ASIC. In addition, the ASIC may be located in an access network device or a terminal device. Certainly, the processor and the storage medium may alternatively exist in the first entity or the control plane function as discrete components.

All or some of the foregoing embodiments may be implemented by using software, hardware, firmware, or any combination thereof. When the software is used to implement the embodiments, all or some of the embodiments may be implemented in a form of a computer program product. The computer program product includes one or more computer programs or instructions. When the computer programs or instructions are loaded and executed on a computer, all or some of the procedures or functions in embodiments of this application are executed. The computer may be a general-purpose computer, a dedicated computer, a computer network, or another programmable apparatus. The computer programs or the instructions may be stored in a computer-readable storage medium, or may be transmitted through the computer-readable storage medium. The computer-readable storage medium may be any usable medium accessible by a computer, or a data storage device such as a server integrating one or more usable media. The usable medium may be a magnetic medium, for example, a floppy disk, a hard disk, or a magnetic tape; or may be an optical medium, for example, a digital versatile disc (digital versatile disc, DVD); or may be a semiconductor medium, for example, a solid state drive (solid state drive, SSD).

In various embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

It may be understood that various numbers in embodiments of this application are merely used for differentiation for ease of description, and are not used to limit the scope of embodiments of this application. The sequence numbers of the foregoing processes do not mean execution sequences, and the execution sequences of the processes should be determined based on functions and internal logic of the processes.

An embodiment of this application further provides a computer-readable storage medium. The computer-readable storage medium stores computer-executable instructions. When the computer-executable instructions are executed, the method performed by the first entity or the control plane function in the foregoing method embodiments is implemented.

An embodiment of this application further provides a computer program product. The computer program product includes a computer program. When the computer program is executed, the method performed by the first entity or the control plane function in the foregoing method embodiments is implemented.

An embodiment of this application further provides a communication system. The communication system includes a first entity or a control plane function. The first entity is configured to perform the method performed by the first entity in the foregoing method embodiments. The control plane function is used to perform the method performed by the control plane function in the foregoing method embodiments.

It should be noted that, for brief description, the foregoing method embodiments are represented as a series of actions. However, a person skilled in the art should appreciate that this application is not limited to the described sequence of the actions, because according to this application, some steps may be performed in other sequences or simultaneously. It should be further appreciated by a person skilled in the art that embodiments described in this specification all belong to example embodiments, and the involved actions and modules are not necessarily required by this application.

Descriptions of the embodiments provided in this application may refer to each other, and descriptions of the embodiments have different focuses. For a part not described in detail in an embodiment, refer to related descriptions in another embodiment. For ease of description and brevity, for functions and performed steps of the apparatuses and devices provided in embodiments of this application, refer to related descriptions in the method embodiments of this application. Mutual reference, combination, or reference may be made between the method embodiments and between the apparatus embodiments.

Finally, it should be noted that the foregoing embodiments are merely intended for describing the technical solutions of this application other than limiting this application. Although this application is described in detail with reference to the foregoing embodiments, a person of ordinary skill in the art should understand that modifications may still be made to the technical solutions described in the foregoing embodiments or equivalent replacements may be made to some or all technical features thereof, without departing from the scope of the technical solutions of the embodiments of this application.

What is claimed is:

1. A network function creation method, wherein the method comprises:
receiving, by a first entity, a first request message, wherein the first request message is used to request to create or select a user network corresponding to a terminal device, and the first request message comprises a user identifier of the terminal device; and
creating or selecting, by the first entity, a control plane function based on the user identifier, wherein the control plane function is used to create or select a user plane function corresponding to the control plane function, and the user plane function is used to support a subscription service corresponding to the user identifier.

2. The method according to claim 1, wherein the first request message further comprises first information of the user network, and the first information of the user network comprises an identifier of the user network or a type of the user network.

3. The method according to claim 1, wherein the method further comprises:
receiving, by the first entity, a second request message from the control plane function, wherein the second request message is used to request to create or select the user plane function, and the second request message carries first network attribute information or second information of the user network, and the second information of the user network comprises the identifier of the user network or the type of the user network;
creating or selecting, by the first entity, the user plane function based on the first network attribute information or the second information of the user network; and
sending, by the first entity, information about the user plane function to the control plane function.

4. The method according to claim 3, wherein the creating or selecting, by the first entity, the user plane function based on the second information of the user network comprises:
determining, by the first entity, second network attribute information based on the second information of the user network; and
creating or selecting, by the first entity, the user plane function based on the second network attribute information.

5. The method according to claim 1, wherein the method further comprises:
receiving, by the first entity, processed user subscription information based on the user identifier; and
sending, by the first entity, the processed user subscription information to the control plane function, wherein the processed user subscription information is used to create or select the user plane function.

6. A method for creating a user network, wherein the method comprises:
obtaining, by a control plane function, a user identifier; and
creating or selecting, by the control plane function, a user plane function corresponding to the control plane function, wherein the user plane function is used to support a subscription service corresponding to the user identifier.

7. The method according to claim 6, wherein the creating or selecting, by the control plane function, a user plane function corresponding to the control plane function comprises:
obtaining, by the control plane function, user subscription information corresponding to the user identifier; and
creating or selecting, by the control plane function based on the user subscription information, the user plane function corresponding to the control plane function.

8. The method according to claim 7, wherein the creating or selecting, by the control plane function, a user plane function corresponding to the control plane function comprises:
determining, by the control plane function, first network attribute information based on the user subscription information; and creating or selecting, by the control plane function based on the first network attribute information, the user plane function corresponding to the control plane function; or
determining, by the control plane function, first network attribute information based on the user subscription information; sending, by the control plane function, a second request message to the first entity, wherein the second request message is used to request to create or select the user plane function, and the second request message carries the first network attribute information; and receiving, by the control plane function, information about the user plane function from the first entity.

9. The method according to claim 6, wherein the creating or selecting, by the control plane function, a user plane function corresponding to the control plane function comprises:
determining, by the control plane function, second information of the user network, wherein the second information of the user network comprises an identifier of the user network or a type of the user network; and
sending, by the control plane function, a second request message to a first entity, wherein the second request message is used to request to create or select the user plane function, and the second request message carries the second information of the user network.

10. The method according to claim 6, wherein the control plane function corresponds to a plurality of user plane functions, each user plane function is associated with at least one of a data network or a slice, and the method further comprises:
receiving, by the control plane function, a session establishment request from the terminal device, wherein the session establishment request comprises information about a target data network or a target slice; and
determining, by the control plane function from the plurality of user plane functions, a target user plane function corresponding to the target data network or the target slice, wherein the target user plane function is used to provide the terminal device with a network service corresponding to the target data network or the target slice.

11. A communication apparatus, comprising a processor, wherein the processor is coupled to a memory storing instructions, when the instructions are executed by the processor, cause the communication apparatus to:
receive a first request message, wherein the first request message is used to request to create or select a user network corresponding to a terminal device, and the first request message comprises a user identifier of the terminal device; and
create a control plane function based on the user identifier, wherein the control plane function is used to create or select a user plane function corresponding to the control plane function, and the user plane function is used to support a subscription service corresponding to the user identifier.

12. The communication apparatus according to claim 11, wherein the first request message further comprises first information of the user network, and the first information of the user network comprises an identifier of the user network or a type of the user network.

13. The communication apparatus according to claim 11, when the instructions are executed by the processor, further cause the communication apparatus to:
receive a second request message from the control plane function, wherein the second request message is used to request to create or select the user plane function, and the second request message carries first network attribute information or second information of the user network, and the second information of the user network comprises the identifier of the user network or the type of the user network;
create, the user plane function based on the first network attribute information or the second information of the user network; and
send information about the user plane function to the control plane function.

14. The communication apparatus according to claim 13, when the instructions are executed by the processor, specifically cause the communication apparatus to:
determine second network attribute information based on the second information of the user network; and
create or select the user plane function based on the second network attribute information.

15. The communication apparatus according to claim 11, when the instructions are executed by the processor, further cause the communication apparatus to:
receive processed user subscription information based on the user identifier; and
send the processed user subscription information to the control plane function, wherein the processed user subscription information is used to create or select the user plane function.

16. A communication apparatus, comprising a processor, wherein the processor is coupled to a memory storing instructions, when the instructions are executed by the processor, cause the communication apparatus to:
obtain a user identifier; and
create a user plane function corresponding to the communication apparatus, wherein the user plane function is used to support a subscription service corresponding to the user identifier.

17. The communication apparatus according to claim 16, when the instructions are executed by the processor, specifically cause the communication apparatus to:
obtain user subscription information corresponding to the user identifier; and
create or select based on the user subscription information, the user plane function corresponding to the communication apparatus.

18. The communication apparatus according to claim 17, when the instructions are executed by the processor, specifically cause the communication apparatus to:
determine first network attribute information based on the user subscription information; and create or select based on the first network attribute information, the user plane function corresponding to the communication apparatus; or
determine first network attribute information based on the user subscription information; send a second request message to the first entity, and receive information about the user plane function from the first entity; wherein the second request message is used to request to create or select the user plane function, and the second request message carries the first network attribute information.

19. The communication apparatus according to claim 16, when the instructions are executed by the processor, specifically cause the communication apparatus to:
determine second information of the user network, wherein the second information of the user network comprises an identifier of the user network or a type of the user network; and
send a second request message to a first entity, wherein the second request message is used to request to create or select the user plane function, and the second request message carries the second information of the user network.

20. The communication apparatus according to claim 16, wherein the communication apparatus corresponds to a plurality of user plane functions, each user plane function is associated with at least one of a data network or a slice, and when the instructions are executed by the processor, further cause the communication apparatus to:
receive a session establishment request from the terminal device, wherein the session establishment request comprises information about a target data network or a target slice; and
determine from the plurality of user plane functions, a target user plane function corresponding to the target data network or the target slice, wherein the target user plane function is used to provide the terminal device with a network service corresponding to the target data network or the target slice.
